(19) United States
(12) Patent Application Publication
(10) Pub. No.: US 2015/0128647 A1
(43) Pub. Date: May 14, 2015

(54) GLASS FURNACE FOREHEARTH HEATING

(71) Applicants: Osemwengie Uyi Iyoha, Amherst, NY (US); Arthur W. Francis, JR., Monroe, NY (US); Mark A. Kailburn, North Tonawanda, NY (US); Abilio Tasca, Sao Paulo (BR)

(72) Inventors: Osemwengie Uyi Iyoha, Amherst, NY (US); Arthur W. Francis, JR., Monroe, NY (US); Mark A. Kailburn, North Tonawanda, NY (US); Abilio Tasca, Sao Paulo (BR)

(21) Appl. No.: 14/496,882

(22) Filed: Sep. 25, 2014

Related U.S. Application Data
(60) Provisional application No. 61/883,512, filed on Sep. 27, 2013.

(51) Int. Cl. C03B 5/235; C03B 5/42

(52) U.S. Cl. CPC C03B 5/2353; C03B 5/42
USPC 65/134.4

(57) ABSTRACT

Described are a burner and its method of operation that are useful in providing heat within an enclosure such as the forehearth associated with a glassmelting furnace.

### FIELD OF THE INVENTION

The present invention relates to heating molten glass in the forehearth of a glass furnace.

### BACKGROUND OF THE INVENTION

The production of articles of glass customarily involves feeding solid starting materials such as soda ash and silica, and/or recycled pieces of glass, into a glassmelting furnace in which the starting materials are melted to produce molten glass which flows out of the glassmelting furnace, through one or more passages known as forehearths, to apparatus in which the molten glass is formed into the desired products.

It is desirable to provide heat to the molten glass flowing through the forehearth, in order to maintain the molten glass in a sufficiently flowable condition and to compensate for any heat losses at the surface of the molten glass so as to promote temperature uniformity throughout the molten glass. The present invention provides apparatus and methodology to do this, in a way that improves efficiency and avoids drawbacks such as losses of material or deterioration of the apparatus that is used to heat the molten glass.

### BRIEF SUMMARY OF THE INVENTION

One aspect of the present invention is a method of heating molten glass adjacent to a side wall of a glass furnace forehearth in which the molten glass is flowing, or other high temperature stream, comprising

into a burner that extends into the forehearth above the molten glass from a side wall of the forehearth, wherein the burner comprises

an oxidant conduit having an inlet outside the forehearth and an outlet within the forehearth, and a fuel conduit having an inlet outside the forehearth and an outlet within the forehearth, wherein said outlets open in a direction which is upstream or downstream relative to the direction in which said molten glass is flowing,

each conduit having a first segment extending from the side wall into the forehearth and a second segment extending from the end of the first segment to the conduit outlet, wherein each second segment is at an angle relative to the first segment, so that the axes of the conduit outlets form an angle relative to the side wall of 5 to 30 degrees projected in the horizontal plane and form an angle relative to the horizontal plane of 0 degrees to 5 degrees upward,

refractory material encasing the conduits that protects the conduits from degradation by the forehearth conditions and protects gaseous fuel in the fuel conduit from thermal decomposition, and

an opening in the refractory material aligned with the fuel conduit outlet and the oxidant conduit outlet, wherein the fuel conduit outlet and the oxidant conduit outlet are recessed relative to the outer surface of the opening in the refractory material, and the opening in the refractory material is straight or diverges outwardly from the oxidant conduit outlet to the outer surface of the refractory material,

wherein the fuel and oxidant conduit outlets are recessed from the refractory opening a distance of 1 to 6 times the inner diameter of the oxidant conduit outlet, and

wherein the distance from the axis of the fuel conduit at the fuel conduit outlet to the side wall from which the burner extends is 4 to 10 times the inner diameter of the outlet of the oxidant conduit,

feeding fuel into the fuel conduit inlet at a rate so that the fuel emerges from the fuel conduit outlet at a velocity of 40 to 300 fps and feeding oxidant into the oxidant conduit inlet at a rate so that the oxidant emerges from the oxidant conduit outlet at a velocity of 3 to 100 fps, and the ratio of the oxidant velocity to the fuel velocity at said outlets is 1:1 to 1:20,

and combusting oxidant and fuel that emerge from said outlets at the opening in the refractory material to produce a flame and heat of combustion in close proximity to the sidewall of a glass furnace forehearth.

In a preferred embodiment, one of said conduits is within the other of said conduits.

Another aspect of the invention is a method of heating molten glass adjacent to a side wall of a glass furnace forehearth in which the molten glass is flowing, or other high temperature stream, comprising

into a burner that extends into the forehearth above the molten glass from a side wall of the forehearth, wherein the burner comprises

first and second oxidant conduits each having an inlet outside the forehearth and an outlet within the forehearth, and first and second fuel conduits having an inlet outside the forehearth and an outlet within the forehearth, wherein the outlets of said first oxidant conduit and said first fuel conduit open in a selected direction which is upstream or downstream relative to the direction in which said molten glass is flowing and the outlets of said second oxidant conduit and said second fuel conduit open in a direction which is opposite to said selected direction,

each conduit having a first segment extending from the side wall into the forehearth and a second segment extending from the end of the first segment to the conduit outlet, wherein each second segment is at an angle relative to the first segment, so that the axes of the conduit outlets form an angle relative to the side wall of 5 to 30 degrees projected in the horizontal plane and form an angle relative to the horizontal plane of 0 degrees to 5 degrees upward,

refractory material encasing the conduits that protects the conduits from degradation by the forehearth conditions and protects gaseous fuel in the fuel conduit from thermal decomposition, and

a first opening in the refractory material aligned with the first fuel conduit outlet and the first oxidant conduit outlet, wherein the first fuel conduit outlet and the first oxidant conduit outlet are recessed relative to the outer surface of the first opening in the refractory material, and a second opening in the refractory material aligned with the second fuel conduit outlet and the second oxidant conduit outlet, wherein the second fuel conduit outlet and the second oxidant conduit outlet are recessed relative to the outer surface of the second opening in the refractory material, and the first and second openings in the refractory material are straight or diverge outwardly from the respective oxidant conduit outlets to the outer surface of the refractory material,

wherein the first and second fuel and oxidant conduit outlets are recessed from the respective first and second refractory openings a distance of 1 to 6 times the inner diameter of the respective oxidant conduit outlets, and

wherein the distance from the axis of the first fuel conduit at its outlet to the side wall from which the burner extends is 4 to 10 times the inner diameter of the outlet of the first oxidant conduit and the distance from the axis of the second fuel conduit at its outlet to the side wall from which the burner extends is 4 to 10 times the inner diameter of the outlet of the second oxidant conduit,

feeding fuel into the first and second fuel conduit inlets at a rate so that the fuel emerges from each fuel conduit outlet at a velocity of 40 to 300 fps and feeding oxidant into the first and second oxidant conduit inlets at a rate so that the oxidant emerges from each oxidant conduit outlet at a velocity of 3 to 100 fps, and the ratio of the oxidant velocity to the fuel velocity at said first oxidant outlet and said first fuel outlet, and the ratio of the oxidant velocity to the fuel velocity at said first oxidant outlet and said first fuel outlet, are each 1:1 to 1:20,

and combusting oxidant and fuel that emerge from said outlets at the first and second openings in the refractory material to produce flames and heat of combustion in close proximity to the sidewall of said glass furnace forehearth.

In a preferred embodiment, one of said first oxidant conduit and said first fuel conduit is within the other and one of said second oxidant conduit and said second fuel conduit is within the other.

Yet another aspect of the invention is a method of heating molten glass adjacent to a side wall of a glass furnace forehearth in which the molten glass is flowing, or other high temperature stream, comprising

into a burner that extends into the forehearth above the molten glass from a side wall of the forehearth, wherein the burner comprises

an oxidant conduit having an inlet outside the forehearth and first and second outlets within the forehearth, and a fuel conduit having an inlet outside the forehearth and a first and second outlets within the forehearth, wherein said first oxidant conduit outlet and said first fuel conduit outlet open in a selected direction which is upstream or downstream relative to the direction in which said molten glass is flowing and said second oxidant conduit outlet and said second fuel conduit outlet open in a direction which is opposite to said selected direction,

each conduit having a first segment extending from the side wall into the forehearth and second and third segments extending from the end of the first segment to the first and second conduit outlets respectively, wherein each second segment and each third segment are at an angle relative to the first segment, so that the axes of the conduit outlets form an angle relative to the side wall of 5 to 30 degrees projected in the horizontal plane and form an angle relative to the horizontal plane of 0 degrees to 5 degrees upward,

refractory material encasing the conduits that protects the conduits from degradation by the forehearth conditions and protects gaseous fuel in the fuel conduit from thermal decomposition, and

a first opening in the refractory material aligned with the first fuel conduit outlet and the first oxidant conduit outlet, wherein the first fuel conduit outlet and the first oxidant conduit outlet are recessed relative to the outer surface of the first opening in the refractory material, and a second opening in the refractory material aligned with the second fuel conduit outlet and the second oxidant conduit outlet, wherein the second fuel conduit outlet and the second oxidant conduit outlet are recessed relative to the outer surface of the second opening in the refractory material, and the first and second openings in the refractory material are straight or diverge outwardly from the respective oxidant conduit outlets to the outer surface of the refractory material,

wherein the first and second fuel and oxidant conduit outlets are recessed from the respective first and second refractory openings a distance of 1 to 6 times the inner diameter of the respective oxidant conduit outlets, and

wherein the distance from the axis of the first fuel conduit at its outlet to the side wall from which the burner extends is 4 to 10 times the inner diameter of the outlet of the first oxidant conduit and the distance from the axis of the second fuel conduit at its outlet to the side wall from which the burner extends is 4 to 10 times the inner diameter of the outlet of the second oxidant conduit,

feeding fuel into the fuel conduit inlet at a rate so that the fuel emerges from each fuel conduit outlet at a velocity of 40 to 300 fps and feeding oxidant into the oxidant conduit inlet at a rate so that the oxidant emerges from each oxidant conduit outlet at a velocity of 3 to 100 fps, and the ratio of the oxidant velocity to the fuel velocity at said first oxidant outlet and said first fuel outlet, and the ratio of the oxidant velocity to the fuel velocity at said first oxidant outlet and said first fuel outlet, are each 1:1 to 1:20,

and combusting oxidant and fuel that emerge from said outlets at the first and second openings in the refractory material to produce flames and heat of combustion in close proximity to the sidewall of said glass furnace forehearth.

In a preferred embodiment, one of said conduits is within the other of said conduits.

In other preferred embodiments, the amount of oxygen fed from its oxidant outlet is insufficient to completely combust with the fuel that is fed from the adjacent fuel outlet, and auxiliary oxygen is fed into the forehearth to combust with the fuel.

A further aspect of this invention is carrying out the above feeding and combusting operations in a forehearth with a plurality of burners as described herein.

### BRIEF DESCRIPTION OF THE DRAWINGS

FIG. 1 is a perspective view of a portion of a forehearth including a burner in accordance with the present invention.

FIG. 2 is a top cross-sectional view of a portion of the forehearth portion shown in FIG. 1, seen in the plane formed by line 2′-2″ that appears in FIG. 1.

FIG. 3 is a cutaway view of a portion of the burner that is shown in FIG. 2.

FIG. 4 is a perspective view of a portion of a forehearth showing another embodiment of the present invention.

FIG. 5 is a top cross-sectional view of a portion of the forehearth portion shown in FIG. 4, seen in the plane formed by the line 5′-5″ that appears in FIG. 4.

FIG. 6 is a top cross-sectional view of a portion of the forehearth showing another embodiment of the present invention.

FIG. 7 is a top cross-sectional view of a portion of the forehearth showing another embodiment of the present invention.

FIG. 8 is a top cross-sectional view of a portion of the forehearth showing another embodiment of the present invention.

### DETAILED DESCRIPTION OF THE INVENTION

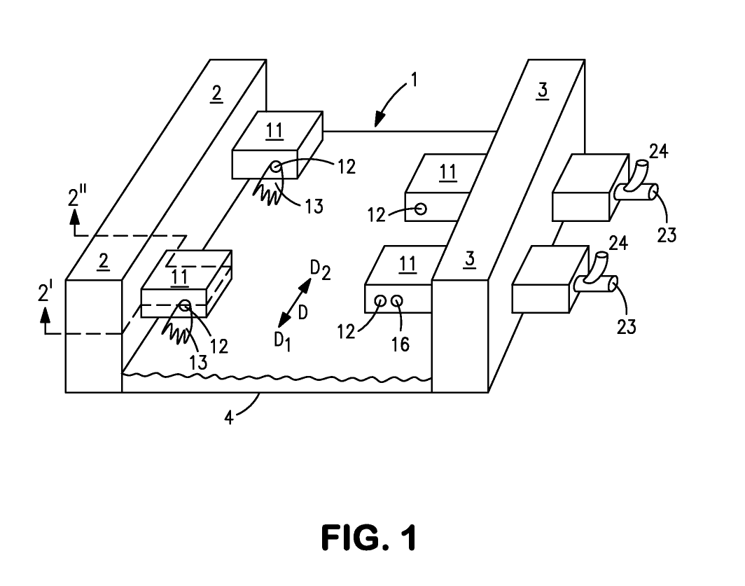

FIG. 1 depicts one representative embodiment of the practice of the present invention. This embodiment is illustrative, so the present invention is not to be limited to the embodiment in the Figures of this application.

As seen in FIG. 1, a forehearth 1 includes side walls 2 and 3 and bottom 4 which together define a channel through which molten glass 5 is held and flows as indicated by arrow D. The molten glass may be flowing in the direction from D2 toward D1, in which case the flames 13 are oriented to extend downstream relative to the direction in which the molten glass is flowing, or the molten glass may be flowing in the direction from D1 toward D2, in which case the flames 13 are oriented upstream relative to the direction in which the molten glass is flowing. Burner 11 extends from side wall 2 into the interior of the forehearth 1, above molten glass 5. Burner 11 includes opening 12 from which, during operation of burner 11, flame 13 extends within forehearth 1.

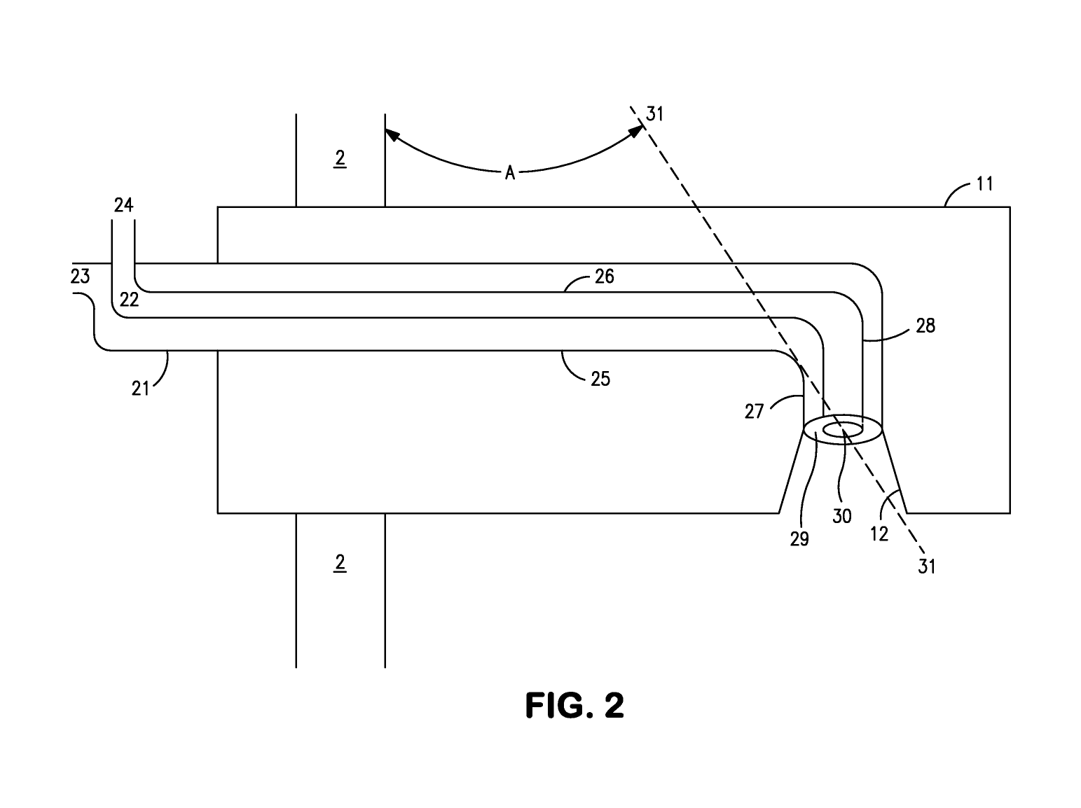

FIG. 2 illustrates the side wall 2 and burner 11 of FIG. 1, as seen from directly above burner 11, in a cross-sectional view in a horizontal plane taken along line 2′-2″ which appears in FIG. 1. As seen in FIG. 2, burner 11 extends through a suitable opening in side wall 2. Preferably there is as little free space as possible between burner 11 and side wall 2, where burner 11 passes through side wall 2, in order to minimize or prevent passage of gases out of the forehearth or into the forehearth from the surrounding atmosphere.

Oxidant conduit 21 extends from oxidant conduit inlet 23 which is outside the forehearth, through first segment 25 and second segment 27, and terminates at oxidant conduit outlet 29. Fuel conduit 22 extends from fuel conduit inlet 24 which is outside the forehearth, through first segment 26 and second segment 28, and terminates at fuel conduit outlet 30. First segment 25 is angled with respect to second segment 27, and first segment 26 is angled with respect to second segment 28, so that each conduit extends into the forehearth in a direction generally across the direction of flow of the molten glass, then turns toward the respective outlets, and terminates in the outlets that are generally aligned to open in a direction that is upstream or downstream relative to the direction of flow of the molten glass. The respective first and second segments of each conduit can be defined by a bend in the conduit (which form a gradually curving connection between the segments), or by a joint between the two segments of conduit (which form a relatively sharp angle). More specifically, the axis 31 of each of the conduits at the respective openings forms an angle of 5 degrees to 30 degrees relative to the side wall 2, when projected in a horizontal plane. This angle is shown as angle A in FIG. 2. The axis 31 also forms an angle of zero degrees (i.e. horizontal) to 5 degrees above horizontal, relative to the horizontal plane.

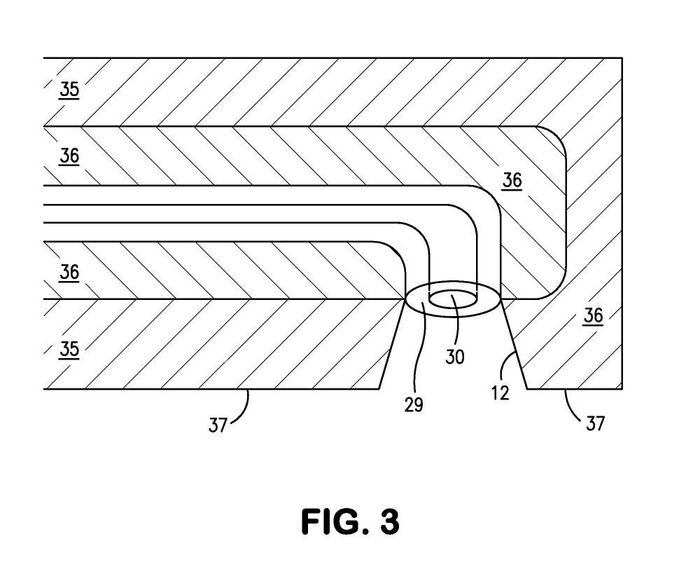

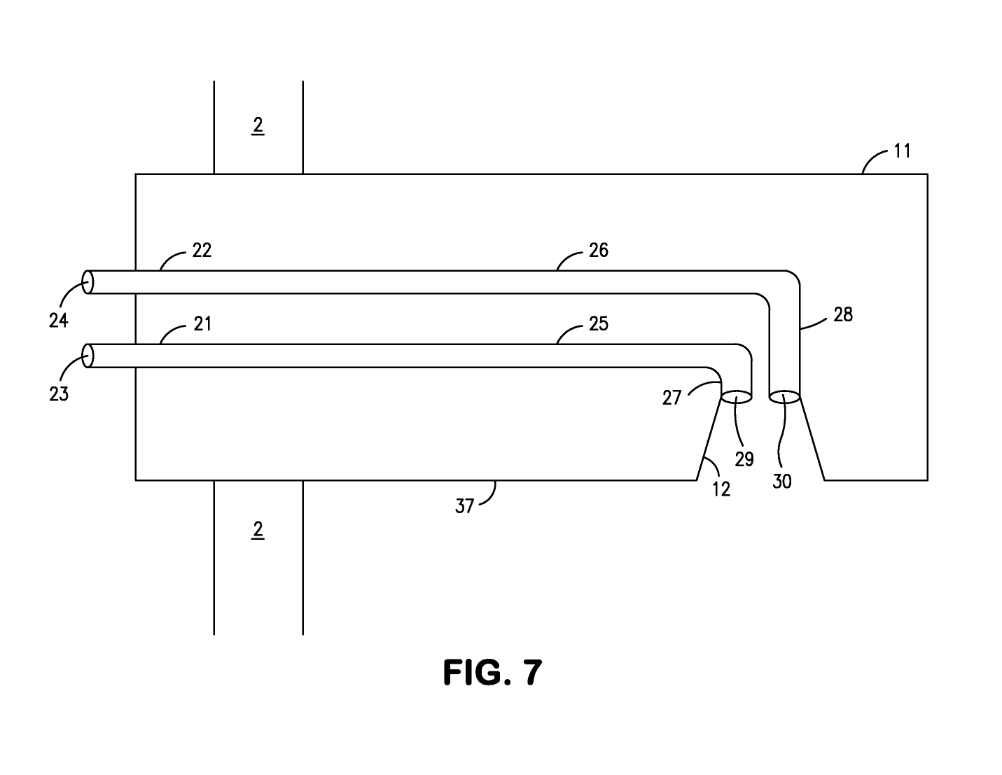

In FIGS. 2 and 3, the fuel conduit is inside the oxidant conduit. This construction is preferred, although the conduits can instead be arranged so that the oxidant conduit is inside the fuel conduit. Alternatively, the fuel conduit and the oxidant conduit can be next to each other rather than one inside the other, as shown in FIG. 7 in which the reference numerals have the same meanings as with respect to FIGS. 2 and 3.

Burner 11 extends into the forehearth a distance such that the distance from the side wall 2 from which burner 11 extends, to the axis 31 of the fuel conduit outlet, at the fuel conduit outlet 30, is 4 to 10 times the inner diameter of the oxidant conduit outlet 29. Preferably, this distance is 4 to 6, and more preferably 4 to 5, times the inner diameter of the oxidant conduit outlet 29.

Burner 11 includes refractory material that encases the oxidant conduit and the fuel conduit, to protect the conduits from degradation by the conditions within the forehearth of high temperature and potentially corrosive atmosphere. Preferably there are two layers of different refractory material, shown in FIG. 3 as layers 35 and 36. Layer 35 denotes a layer of material that provides protection against high temperature and a corrosive, highly-alkaline atmosphere. Examples of suitable material for this function include AZS (alumina-zirconia-silica), and alumina-silica, or chrome-alumina. Layer 36 denotes a layer of material that provides protection against high temperatures and that also has low thermal conductivity, preferably thermal conductivity at 1500 degrees Fahrenheit that is no greater than a value of 2 BTU/square foot/hour/degreeFahrenheit/inch of thickness. Examples of suitable material for this function include “Delta t Crete 25” from Mt. Savage Refractory Co. If desired, layers 35 and 36 can be comprised of the same material, provided that the desired properties of protection and low thermal conductivity are provided.

The oxidant conduits and the fuel conduits can be made of any metal or ceramic material that can retain its structural integrity when used (encased in the refractory material) at the temperatures which are encountered within the forehearth. Examples of materials having the desired properties include stainless steel grades 304, 316, 310, and 321, and Inconel and Incoloy. Other examples are known in this field and can readily be identified.

Opening 12 extends from the interior of the burner 11, through the refractory material, to provide access from the outlets of the fuel conduit and the oxidant conduit to the interior of the forehearth. Opening 12 can be straight, by which is meant that the sides of opening 12 can be parallel to each other and to the axis of the fuel conduit opening, or opening 12 can diverge outwardly. FIG. 3 shows an embodiment in which opening 12 diverges outwardly from the oxidant conduit outlet 29 and the fuel conduit outlet 30 toward the outer surface 37 of the burner 11. Thus, the angle formed by opening 12 is preferably zero degrees (straight) or greater than zero up to 11 degrees (diverging) relative to the axis of the fuel conduit opening.

The oxidant conduit outlet 29 and the fuel conduit outlet 30 are recessed relative to the outer surface 37 of the burner 11. Preferably, each of the oxidant conduit outlet and the fuel conduit outlet are recessed, relative to outer surface 37, a distance of 1.5 to 6 times the inner diameter of the oxidant conduit outlet 29. This recessing helps protect against degradation of the conduit outlets and helps prevent formation of soot and other undesired byproducts at the openings 12 and 30. The outlet ends can be flush with each other but are not required to be flush with each other.

The burner 11 is preferably situated relative to the molten glass such that the distance from the upper surface of the molten glass to the fuel conduit outlet is at least 5 times the inner diameter of the oxidant conduit outlet, and preferably 10 to 30 and more preferably 20 to 30 times the inner diameter of the oxidant conduit outlet.

For operation of this embodiment of the present invention, the oxidant conduit inlet 23 is connected to a source of oxidant, associated with controls to permit the operator to control whether or not oxidant flows through the oxidant conduit and to control the rate of flow of the oxidant in the oxidant conduit. In addition, the fuel conduit inlet 24 is connected to a source of fuel, associated with controls to permit the operator to control whether or not fuel flows through the fuel conduit and to control the rate of flow of the fuel in the fuel conduit.

Suitable oxidants include, oxygen-enriched air having an oxygen content of at least 30 vol.% oxygen, and commercial-grade oxygen having an oxygen content of at least 88 vol.%.

Suitable fuels include any combustible gaseous, atomized liquid or solid (in finely divided form) material. Preferred examples include gaseous hydrocarbons and gaseous mixtures of hydrocarbons, including methane and natural gas, as well as atomized fuel oil and hydrocarbon liquids and mixtures that are liquid at room temperature and gaseous at temperatures above 1900 degrees Fahrenheit.

In operation, the fuel is fed into the fuel conduit so that the fuel emerges from the fuel conduit outlet at a velocity of 40 to 300 feet per second (fps), and the oxidant is fed into the oxidant conduit so that the oxidant emerges from the oxidant conduit at a velocity of 3 to 100 fps. The ratio of the oxidant velocity to the fuel velocity (at the respective outlets) should be in the range of 1:1 to 1:20.

The fuel and oxidant fed through burner 11 at the rates described herein are combusted as they emerge from their respective outlets. This combustion produces a flame whose base is at opening 30 and which extends from opening 30 in a direction that is up or downstream, preferably upstream, relative to the flow of the molten glass. The flame provides heat to the upper surface of the molten glass, preferentially along the edge of the molten glass closest to the side wall. The flame may not contact the side wall that is closest to the burner from which the flame extends. The axis of the flame is not directed downwards toward the molten glass surface. The flame should not contact the molten glass, but the gas fed through the burner may contact the molten glass at a velocity that is controlled, preferably to less than 33 feet per second at the molten glass surface, to lessen any alkali volatilization.

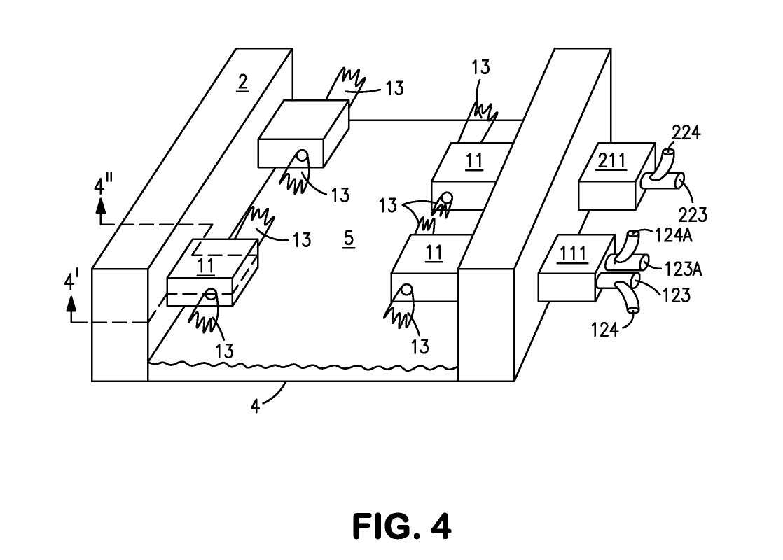

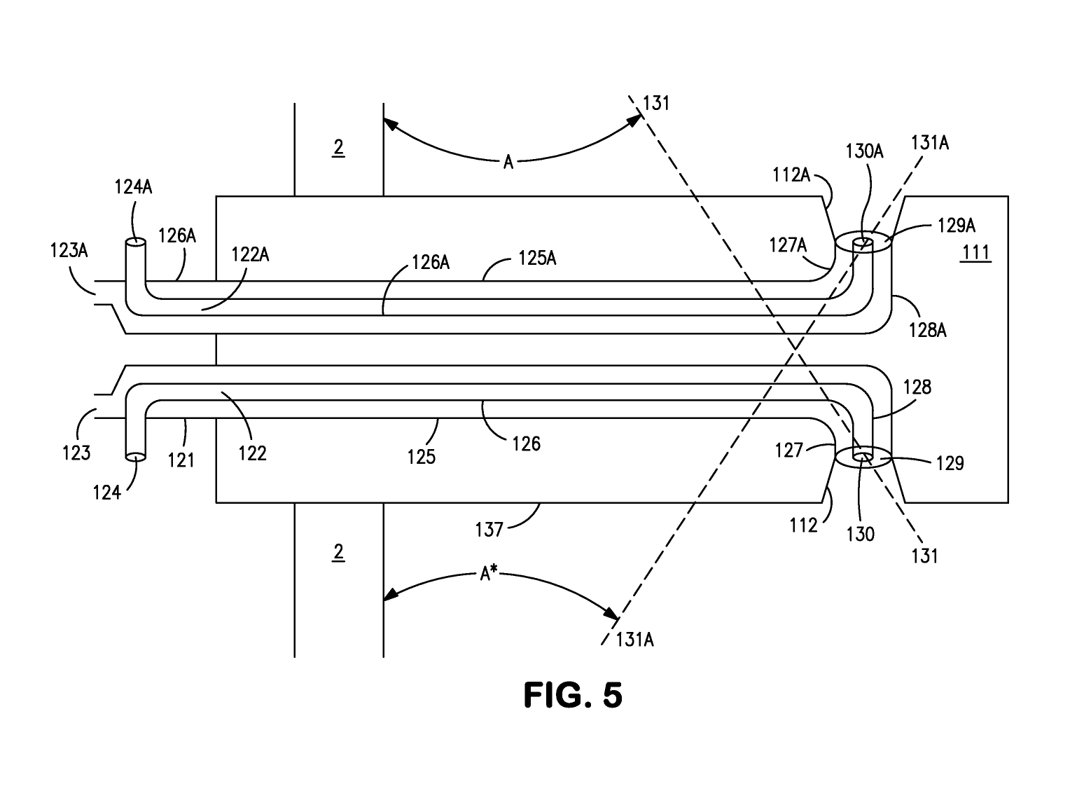

FIGS. 4 and 5 depict another embodiment of the practice of the present invention.

As seen in FIG. 4, the forehearth 1, side walls 2 and 3, and bottom 4, and the channel through which molten glass 5 is held and flows, are as described above with respect to FIG. 1. Flames 13 produced by burner 111 are oriented to extend both downstream and upstream relative to the direction in which the molten glass is flowing. Burner 111 extends from side wall 2 into the interior of the forehearth 1, above molten glass 5. Burner 111 includes openings 112 and 112A from which, during operation of burner 111, flames 13 extend within forehearth 1.

FIG. 5 illustrates the side wall 2 and burner 111 of FIG. 4, as seen from directly above burner 11, in a cross-sectional view in a horizontal plane taken along line 4′-4″ which appears in FIG. 4. As seen in FIG. 5, burner 111 extends through a suitable opening in side wall 2. Preferably there is as little free space as possible between burner 111 and side wall 2, where burner 111 passes through side wall 2, in order to minimize or prevent passage of gases out of the forehearth or into the forehearth from the surrounding atmosphere.

First oxidant conduit 121 extends from first oxidant conduit inlet 123 which is outside the forehearth, through first segment 125 and second segment 127, and terminates at first oxidant conduit outlet 129. First fuel conduit 122 extends from first fuel conduit inlet1 124 which is outside the forehearth, through first segment 126 and second segment 128, and terminates at first fuel conduit outlet 130. First segment 125 is angled with respect to second segment 127, and first segment 126 is angled with respect to second segment 128, so that each conduit extends into the forehearth in a direction generally across the direction of flow of the molten glass, then turns toward the respective outlets, and terminates in the outlets that are generally aligned to open in a direction that is upstream or downstream relative to the direction of flow of the molten glass.

Second oxidant conduit 121A extends from second oxidant conduit inlet 123A which is outside the forehearth, through first segment 125A and second segment 127A, and terminates at second oxidant conduit outlet 129A. Second fuel conduit 122A extends from second fuel conduit inlet 124A which is outside the forehearth, through first segment 126A and second segment 128A, and terminates at second fuel conduit outlet 130A. First segment 125A is angled with respect to second segment 127A, and first segment 126A is angled with respect to second segment 128A, so that each conduit extends into the forehearth in a direction generally across the direction of flow of the molten glass, then turns toward the respective outlets, and terminates in the outlets that are generally aligned to open in a direction that is upstream or downstream relative to the direction of flow of the molten glass.

The respective first and second segments of each conduit can be defined by a bend in the conduit (which form a gradually curving connection between the segments), or by a joint between the two segments of conduit (which form a relatively sharp angle). More specifically, the axes 131 and 131A of each of the conduits at the respective openings forms an angle of 5 degrees to 30 degrees relative to the side wall 2, when projected in a horizontal plane. These angles are shown as angles A and A* in FIG. 5. The axes 131 and 131A also form an angle of zero degrees (i.e. horizontal) to 5 degrees above horizontal, relative to the horizontal plane.

In FIG. 5, the fuel conduits are inside the oxidant conduits. This construction is preferred, although the conduits can instead be arranged so that each oxidant conduit is inside a fuel conduit. Alternatively, the fuel conduits and the oxidant conduits can be next to each other rather than one inside the other, as shown in FIG. 7 except that there would be two pairs of conduits rather than the one pair shown in FIG. 7.

Burner 111 extends into the forehearth a distance such that the distance from the side wall 2 from which burner 111 extends, to the axes 131 and 131A of the first and second fuel conduit outlets, at the fuel conduit outlets 130 and 130A, is 4 to 10 times the inner diameter of the oxidant conduit outlet 129. Preferably, this distance is 4 to 6, and more preferably 4 to 5, times the inner diameter of the oxidant conduit outlet 129.

Burner 111 includes refractory material that encases the oxidant conduit and the fuel conduit, to protect the conduits from degradation by the conditions within the forehearth of high temperature and potentially corrosive atmosphere. Preferably there are two layers of different refractory material, as described herein with respect to burner 11 and as shown in FIG. 3 as layers 35 and 36. One layer of refractory material on burner 111 would be material that provides protection against high temperature and a corrosive, highly-alkaline atmosphere. Examples of suitable material for this function include AZS (alumina-zirconia-silica), and alumina-silica, or chrome-alumina. The other layer on burner 111 would be material that provides protection against high temperatures and that also has low thermal conductivity, preferably thermal conductivity at 1500 degrees Fahrenheit that is no greater than a value of 2 BTU/square foot/hour/degreeFahrenheit/inch of thickness. Examples of suitable material for this function include “Delta t Crete 25” from Mt. Savage Refractory Co. If desired, the layers of refractory material on burner 111 can be comprised of the same material, provided that the desired properties of protection and low thermal conductivity are provided.

The conduits 121, 121A, 122 and 122A can be made of any metal or ceramic material that can retain its structural integrity when used (encased in the refractory material) at the temperatures which are encountered within the forehearth. Examples of materials having the desired properties include stainless steel grades 304, 316, 310, and 321, and Inconel and Incoloy. Other examples are known in this field and can readily be identified.

Openings 112 and 112A extend from the interior of the burner 111, through the refractory material, to provide access from the outlets of the fuel conduits and the oxidant conduits to the interior of the forehearth. Openings 112 and 112A can be straight, by which is meant that the sides of openings 112 and/or 112A can be parallel to each other and to the axis of the fuel conduit opening, or openings 112 and/or 112A can diverge outwardly. FIG. 5 shows an embodiment in which the opening 112 diverges outwardly from the oxidant conduit outlet 129 and the fuel conduit outlet 130 toward the outer surface 137 of the burner 111, and the opening 112A diverges outwardly from the oxidant conduit outlet 129A and the fuel conduit outlet 130A toward the outer surface 137 of the burner 111. Thus, the angles formed by openings 112 and 112A are preferably zero degrees (straight) or greater than zero up to 11 degrees (diverging) relative to the axes of the respective fuel conduit openings.

The oxidant conduit outlets 129 and 129A, and the fuel conduit outlets 130 and 130A, are recessed relative to the outer surface 137 of the burner 111. Preferably, each of the oxidant conduit outlets and the fuel conduit outlets are recessed, relative to outer surface 137, a distance of 1.5 to 6 times the inner diameter of the oxidant conduit outlet 129. This recessing helps protect against degradation of the conduit outlets and helps prevent formation of soot and other undesired byproducts at the openings 112 and 130. The ends of the fuel and oxidant outlets can be flush with each other but are not required to be flush with each other.

The burner 111 is preferably situated relative to the molten glass such that the distance from the upper surface of the molten glass to the fuel conduit outlet 130 is at least 5 times the inner diameter of the oxidant conduit outlet 129, and preferably 10 to 30 and more preferably 20 to 30 times the inner diameter of the oxidant conduit outlet 129.

For operation of this embodiment of the present invention, the oxidant conduit inlets 123 and 123A are connected to a source of oxidant, associated with controls to permit the operator to control whether or not oxidant flows through the oxidant conduits and to control the rate of flow of the oxidant in the oxidant conduits. In addition, the fuel conduit inlets 124 and 124A are connected to a source of fuel, associated with controls to permit the operator to control whether or not fuel flows through the fuel conduits and to control the rate of flow of the fuel in the fuel conduits.

Suitable oxidants and fuels include those described herein above.

In operation, the fuel is fed into the fuel conduits so that the fuel emerges from each of the fuel conduit outlets at a velocity of 40 to 300 feet per second (fps), and the oxidant is fed into the oxidant conduits so that the oxidant emerges from each of the oxidant conduit outlets at a velocity of 3 to 100 fps. The ratio of the oxidant velocity to the fuel velocity (at each of the respective outlets) should be in the range of 1:1 to 1:20.

The fuel and oxidant fed through burner 111 at the rates described herein are combusted as they emerge from their respective outlets. This combustion produces flames whose bases are at openings 130 and 130A and which extend from openings 130 and 130A in directions downstream and upstream relative to the flow of the molten glass. The flames provide heat to the upper surface of the molten glass, preferentially along the edge of the molten glass closest to the side wall. The flame may not contact the side wall that is closest to the burner from which the flame extends. The axis of the flame is not directed downwards toward the molten glass surface. The flame should not contact the molten glass, but the gas fed through the burner may contact the molten glass at a velocity that is controlled, preferably to less than 33 feet per second at the molten glass surface, to lessen any alkali volatilization.

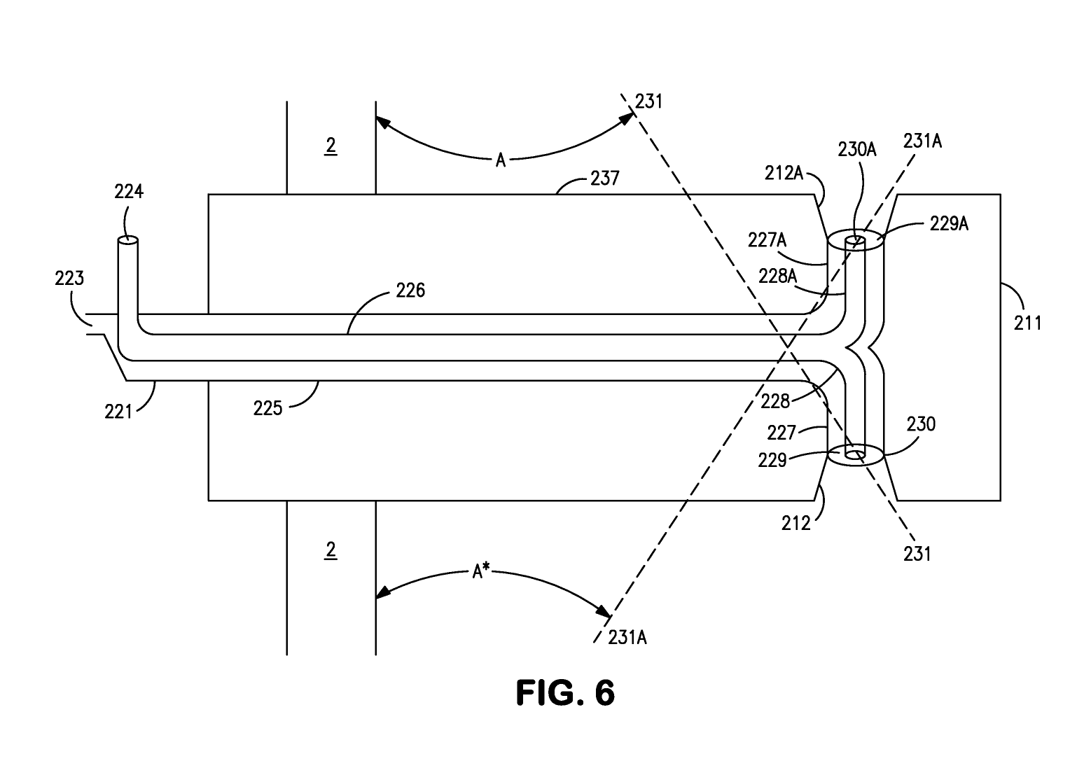

Another embodiment of the practice of the present invention is described with reference to FIGS. 4 and 6.

The embodiment of FIG. 6, referred to as burner 211, can be positioned in a forehearth 1 in the manner as shown in FIG. 4. The forehearth 1, side walls 2 and 3, and bottom 4, and the channel through which molten glass 5 is held and flows, are as described above with respect to FIG. 1. Flames 13 produced by burner 211 are oriented to extend both downstream and upstream relative to the direction in which the molten glass is flowing. Burner 211 extends from side wall 2 into the interior of the forehearth 1, above molten glass 5. Burner 211 includes openings 112 and 112A from which, during operation of burner 211, flames 13 extend within forehearth 1.

FIG. 6 illustrates the side wall 2 and burner 211 of FIG. 1, as seen from directly above burner 11, in a cross-sectional view in a horizontal plane taken along line 6′-6″ which appears in FIG. 4. As seen in FIG. 6, burner 211 extends through a suitable opening in side wall 2. Preferably there is as little free space as possible between burner 211 and side wall 2, where burner 211 passes through side wall 2, in order to minimize or prevent passage of gases out of the forehearth or into the forehearth from the surrounding atmosphere.

Oxidant conduit 221 extends from oxidant conduit inlet 223 which is outside the forehearth, through first segment 225, and splits into second segments 227 and 227A, which terminate at first oxidant conduit outlet 229 and second oxidant conduit outlet 229A. Fuel conduit 222 extends from fuel conduit inlet 224 which is outside the forehearth, through first segment 226, and splits into second segments 228 and 228A, which terminate at first fuel conduit outlet 230 and second fuel conduit outlet 230A. First segment 225 is angled with respect to second segments 227 and 227A, and first segment 226 is angled with respect to second segments 228 and 228A, so that each conduit extends into the forehearth in a direction generally across the direction of flow of the molten glass, then turns toward the respective outlets, and terminates in the outlets that are generally aligned to open in a direction that is upstream or downstream relative to the direction of flow of the molten glass.

The respective second segments of each conduit can be defined relative to the respective first segments by a bend in the conduit (which form a gradually curving connection between the segments), or by a joint between the segments of conduit (which form a relatively sharp angle). More specifically, the axes 231 and 231A of each of the conduits at the respective openings form an angle of 5 degrees to 30 degrees relative to the side wall 2, when projected in a horizontal plane. These angles are shown as angles A and A* in FIG. 6. The axes 231 and 231A also form an angle of zero degrees (i.e. horizontal) to 5 degrees above horizontal, relative to the horizontal plane.

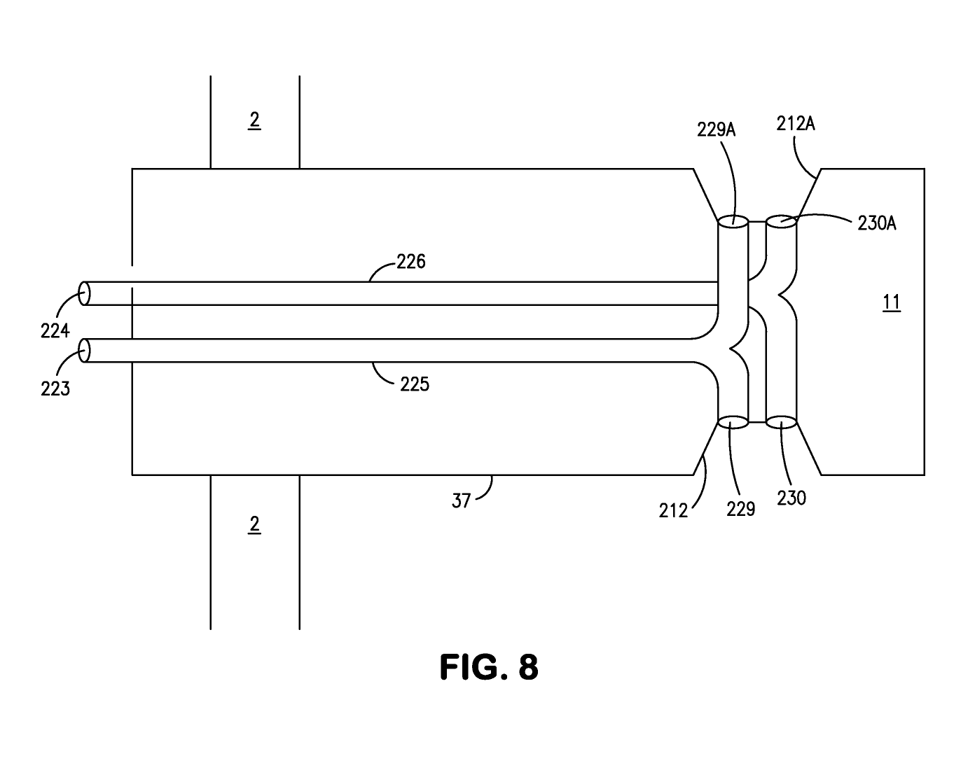

In FIG. 6, the fuel conduit is inside the oxidant conduit. This construction is preferred, although the conduits can instead be arranged so that the oxidant conduit is inside the fuel conduit. Alternatively, the fuel conduit and the oxidant conduit can be next to each other rather than one inside the other, as shown in FIG. 8 in which the reference numerals have the same meanings as with respect to FIG. 6.

Burner 211 extends into the forehearth a distance such that the distance from the side wall 2 from which burner 211 extends, to the axes 231 and 231A of the first and second fuel conduit outlets, at the fuel conduit outlets 230 and 230A, is 4 to 10 times the inner diameter of the first oxidant conduit outlet 229. Preferably, this distance is 4 to 6, and more preferably 4 to 5, times the inner diameter of the first oxidant conduit outlet 229.

Burner 211 includes refractory material that encases the oxidant conduit and the fuel conduit, to protect the conduits from degradation by the conditions within the forehearth of high temperature and potentially corrosive atmosphere. Preferably there are two layers of different refractory material, as described herein with respect to burner 11 and as shown in FIG. 3 as layers 35 and 36. One layer of refractory material on burner 211 would be material that provides protection against high temperature and a corrosive, highly-alkaline atmosphere. Examples of suitable material for this function include AZS (alumina-zirconia-silica), and alumina-silica, or chrome-alumina. The other layer on burner 211 would be material that provides protection against high temperatures and that also has low thermal conductivity, preferably thermal conductivity at 1500 degrees Fahrenheit that is no greater than a value of 2 BTU/square foot/hour/degreeFahrenheit/inch of thickness. Examples of suitable material for this function include “Delta t Crete 25” from Mt. Savage Refractory Co. If desired, the layers of refractory material on burner 211 can be comprised of the same material, provided that the desired properties of protection and low thermal conductivity are provided.

The conduits 221 and 222 can be made of any metal or ceramic material that can retain its structural integrity when used (encased in the refractory material) at the temperatures which are encountered within the forehearth. Examples of materials having the desired properties include stainless steel grades 304, 316, 310, and 321, and Inconel and Incoloy. Other examples are known in this field and can readily be identified.

Openings 212 and 212A extend from the interior of the burner 111, through the refractory material, to provide access from the outlets of the fuel conduits and the oxidant conduits to the interior of the forehearth. Openings 212 and 212A can be straight, by which is meant that the sides of openings 212 and/or 212A can be parallel to each other and to the axis of the fuel conduit opening, or openings 212 and/or 212A can diverge outwardly. FIG. 6 shows an embodiment in which the opening 212 diverges outwardly from the oxidant conduit outlet 229 and the fuel conduit outlet 230 toward the outer surface 237 of the burner 211, and the opening 212A diverges outwardly from the oxidant conduit outlet 229A and the fuel conduit outlet 230A toward the outer surface 237 of the burner 211. Thus, the angles formed by the openings 212 and 212A are preferably zero degrees (straight) or greater than zero up to 11 degrees (diverging) relative to the axes of the respective fuel conduit openings.

The oxidant conduit outlets 229 and 229A, and the fuel conduit outlets 230 and 230A, are recessed relative to the outer surface 237 of the burner 211. Preferably, each of the oxidant conduit outlets and the fuel conduit outlets are recessed, relative to outer surface 237, a distance of 1.5 to 6 times the inner diameter of the oxidant conduit outlet 229. This recessing helps protect against degradation of the conduit outlets and helps prevent formation of soot and other undesired byproducts at the openings 212 and 230. The ends of the fuel and oxidant outlets can be flush with each other but are not required to be flush with each other.

The burner 211 is preferably situated relative to the molten glass such that the distance from the upper surface of the molten glass to the fuel conduit outlet 230 is at least 5 times the inner diameter of the oxidant conduit outlet 229, and preferably 10 to 30 and more preferably 20 to 30 times the inner diameter of the oxidant conduit outlet 229.

For operation of this embodiment of the present invention, the oxidant conduit inlet 223 is connected to a source of oxidant, associated with controls to permit the operator to control whether or not oxidant flows through the oxidant conduit and to control the rate of flow of the oxidant in the oxidant conduit. In addition, the fuel conduit inlet 224 is connected to a source of fuel, associated with controls to permit the operator to control whether or not fuel flows through the fuel conduit and to control the rate of flow of the fuel in the fuel conduit.

Suitable oxidants and fuels include those described herein above.

In operation, the fuel is fed into the fuel conduit so that the fuel emerges from each of the fuel conduit outlets at a velocity of 40 to 300 feet per second (fps), and the oxidant is fed into the oxidant conduit so that the oxidant emerges from each of the oxidant conduit outlets at a velocity of 3 to 100 fps. The ratio of the oxidant velocity to the fuel velocity (at each of the respective outlets) should be in the range of 1:1 to 1:20.

The fuel and oxidant fed through burner 211 at the rates described herein are combusted as they emerge from their respective outlets. This combustion produces flames whose bases are at openings 230 and 230A and which extend from openings 230 and 230A in directions downstream and upstream relative to the flow of the molten glass. The flames provide heat to the upper surface of the molten glass, preferentially along the edge of the molten glass closest to the side wall. The flame may not contact the side wall that is closest to the burner from which the flame extends. The axis of the flame is not directed downwards toward the molten glass surface. The flame should not contact the molten glass, but the gas fed through the burner may contact the molten glass at a velocity that is controlled, preferably to less than 33 feet per second at the molten glass surface, to lessen any alkali volatilization.

In any of the foregoing embodiments, the amounts of oxidant and fuel fed into the burners should be sufficient so that the combustion produces sufficient heat to maintain the glass molten and flowable along the sidewalls of the forehearth. The amounts of fuel to combust can readily be determined taking into account the heating value and heat of combustion of the fuel being use, the size of the forehearth, and the number of burners being employed.

In one embodiment, the relative amounts of the fuel and the oxygen in the oxidant fed, that emerge from the respective outlets described above, should correspond to a range from 20% stoichiometric excess of oxygen to a 20% excess of fuel. Of course, lesser excess, such as up to 10% or up to 5% excess, are preferable as representing less wasted reagent.

In another embodiment, the amount of oxygen in the oxidant fed from an oxidant outlet is 50% to 90% of the stoichiometric requirement based on the fuel fed from the adjacent outlet, and auxiliary oxidant is fed into the forehearth from an additional port 16 (shown in FIG. 1) on burner 11 and combusts with fuel that is fed from one or more fuel outlets. This provides staging of the combustion, which lessens the formation of oxides of nitrogen (“NOx”) that are considered to be pollutants. The auxiliary oxidant reaches port 16 from a source outside the forehearth, through its own conduit or through a section of conduit that branches off from oxidant conduit 21, 121, 121A, 221 or 221A as the case may be.

In practice, it is advantageous to have more than one burner 11, 111 and/or 211 (or any combination thereof) in a forehearth, each operated as described herein. Burners can be situated through one side wall, or preferably through both side walls as shown in FIGS. 1 and 4. Burners on a side wall are preferably spaced apart so that the distance from the fuel conduit outlet of a given burner to the fuel conduit outlet of the next adjacent burner in the downstream direction is 1 to 6, preferably 2 to 4, and more preferably 1.5 to 3, times the length of the flame produced from the given burner. Burners on opposing side walls can be positioned so that they are directly opposite each other, or staggered so that each burner does not have a burner directly opposite it.

The burners described herein, and the manner of operation described herein, have been found to provide numerous advantages. Controlling the velocities of each stream, and controlling the ratio of the velocities, has been found to reduce or eliminate the overheating of the conduits, to reduce or eliminate deterioration of the refractory material on the outer surfaces of the burner, and to reduce or eliminate the formation of soot and other byproducts at the outlets. The range of velocities described herein avoids excessive cooling of the refractory material in the vicinity of the conduit outlets (which would be the result of higher velocities of the fuel and/or the oxidant), and the lessened cooling leads to lessened condensation of material such as corrosive alkali from the forehearth atmosphere onto the refractory material. The angle of the outlets, and the associated angle of the axis of the flame, lessens the exposure of fuel and oxygen conduits to radiation from the furnace which could cause cracking of the fuel species in the fuel, mitigates the formation of hot spots on the side walls from the radiation and contact of the flame which could lead to deterioration of the side walls, and lessens the exposure of the molten glass surface to the flame which could cause excessive volatilization of material from the molten glass (which could in turn lead to loss of glassmaking material, increased emissions from the forehearth into the atmosphere that is vented from above the molten glass, and/or increased corrosive attack on the exposed surfaces of the forehearth including the crown or roof that may be over the molten glass.

What is claimed is:

1. A method of heating molten glass adjacent to a side wall of a glass furnace forehearth in which the molten glass is flowing, or other high temperature stream, comprising
into a burner that extends into the forehearth above the molten glass from a side wall of the forehearth, wherein the burner comprises
an oxidant conduit having an inlet outside the forehearth and an outlet within the forehearth, and a fuel conduit having an inlet outside the forehearth and an outlet within the forehearth, wherein said outlets open in a direction which is upstream or downstream relative to the direction in which said molten glass is flowing,
each conduit having a first segment extending from the side wall into the forehearth and a second segment extending from the end of the first segment to the conduit outlet, wherein each second segment is at an angle relative to the first segment, so that the axes of the conduit outlets form an angle relative to the side wall of 5 to 30 degrees projected in the horizontal plane and form an angle relative to the horizontal plane of 0 degrees to 5 degrees upward,
refractory material encasing the conduits that protects the conduits from degradation by the forehearth conditions and protects gaseous fuel in the fuel conduit from thermal decomposition, and
an opening in the refractory material aligned with the fuel conduit outlet and the oxidant conduit outlet, wherein the fuel conduit outlet and the oxidant conduit outlet are recessed relative to the outer surface of the opening in the refractory material, and the opening in the refractory material diverges outwardly from the oxidant conduit outlet to the outer surface of the refractory material,
wherein the fuel and oxidant conduit outlets are recessed from the refractory opening a distance of 1 to 6 times the inner diameter of the oxidant conduit outlet, and
wherein the distance from the axis of the fuel conduit at the fuel conduit outlet to the side wall from which the burner extends is 4 to 10 times the inner diameter of the outlet of the oxidant conduit,
feeding fuel into the fuel conduit inlet at a rate so that the fuel emerges from the fuel conduit outlet at a velocity of 40 to 300 fps and feeding oxidant into the oxidant conduit inlet at a rate so that the oxidant emerges from the oxidant conduit outlet at a velocity of 3 to 100 fps, and the ratio of the oxidant velocity to the fuel velocity at said outlets is 1:1 to 1:20,
and combusting oxidant and fuel that emerge from said outlets at the opening in the refractory material to produce a flame and heat of combustion in close proximity to the sidewall of a glass furnace forehearth.

2. A method according to claim 1 further comprising feeding auxiliary oxygen into said forehearth from said burner and combusting furl that emerges from said outlet with auxiliary oxygen.

3. A method according to claim 1 wherein one of said conduits is within the other of said conduits.

4. A method according to claim 3 further comprising feeding auxiliary oxygen into said forehearth from said burner and combusting furl that emerges from said outlet with auxiliary oxygen.

5. A method of heating molten glass adjacent to a side wall of a glass furnace forehearth in which the molten glass is flowing, or other high temperature stream, comprising
into a burner that extends into the forehearth above the molten glass from a side wall of the forehearth, wherein the burner comprises
first and second oxidant conduits each having an inlet outside the forehearth and an outlet within the forehearth, and first and second fuel conduits having an inlet outside the forehearth and an outlet within the forehearth, wherein the outlets of said first oxidant conduit and said first fuel conduit open in a selected direction which is upstream or downstream relative to the direction in which said molten glass is flowing and the outlets of said second oxidant conduit and said second fuel conduit open in a direction which is opposite to said selected direction,
each conduit having a first segment extending from the side wall into the forehearth and a second segment extending from the end of the first segment to the conduit outlet, wherein each second segment is at an angle relative to the first segment, so that the axes of the conduit outlets form an angle relative to the side wall of 5 to 30 degrees projected in the horizontal plane and form an angle relative to the horizontal plane of 0 degrees to 5 degrees upward,
refractory material encasing the conduits that protects the conduits from degradation by the forehearth conditions and protects gaseous fuel in the fuel conduit from thermal decomposition, and
a first opening in the refractory material aligned with the first fuel conduit outlet and the first oxidant conduit outlet, wherein the first fuel conduit outlet and the first oxidant conduit outlet are recessed relative to the outer surface of the first opening in the refractory material, and a second opening in the refractory material aligned with the second fuel conduit outlet and the second oxidant conduit outlet, wherein the second fuel conduit outlet and the second oxidant conduit outlet are recessed relative to the outer surface of the second opening in the refractory material, and the first and second openings in the refractory material diverge outwardly from the respective oxidant conduit outlets to the outer surface of the refractory material,
wherein the first and second fuel and oxidant conduit outlets are recessed from the respective first and second refractory openings a distance of 1 to 6 times the inner diameter of the respective oxidant conduit outlets, and
wherein the distance from the axis of the first fuel conduit at its outlet to the side wall from which the burner extends is 4 to 10 times the inner diameter of the outlet of the first oxidant conduit and the distance from the axis of the second fuel conduit at its outlet to the side wall from which the burner extends is 4 to 10 times the inner diameter of the outlet of the second oxidant conduit,
feeding fuel into the first and second fuel conduit inlets at a rate so that the fuel emerges from each fuel conduit outlet at a velocity of 40 to 300 fps and feeding oxidant into the first and second oxidant conduit inlets at a rate so that the oxidant emerges from each oxidant conduit outlet at a velocity of 3 to 100 fps, and the ratio of the oxidant velocity to the fuel velocity at said first oxidant outlet and said first fuel outlet, and the ratio of the oxidant velocity to the fuel velocity at said first oxidant outlet and said first fuel outlet, are each 1:1 to 1:20,
and combusting oxidant and fuel that emerge from said outlets at the first and second openings in the refractory material to produce flames and heat of combustion in close proximity to the sidewall of said glass furnace forehearth.

6. A method according to claim 5 further comprising feeding auxiliary oxygen into said forehearth from said burner and combusting furl that emerges from said outlet with auxiliary oxygen.

7. A method according to claim 5 wherein one of said first oxidant conduit and said first fuel conduit is within the other and one of said second oxidant conduit and said second fuel conduit is within the other.

8. A method according to claim 7 further comprising feeding auxiliary oxygen into said forehearth from said burner and combusting furl that emerges from said outlet with auxiliary oxygen.

9. A method of heating molten glass adjacent to a side wall of a glass furnace forehearth in which the molten glass is flowing, or other high temperature stream, comprising
into a burner that extends into the forehearth above the molten glass from a side wall of the forehearth, wherein the burner comprises
an oxidant conduit having an inlet outside the forehearth and first and second outlets within the forehearth, and a fuel conduit having an inlet outside the forehearth and a first and second outlets within the forehearth, wherein said first oxidant conduit outlet and said first fuel conduit outlet open in a selected direction which is upstream or downstream relative to the direction in which said molten glass is flowing and said second oxidant conduit outlet and said second fuel conduit outlet open in a direction which is opposite to said selected direction,
each conduit having a first segment extending from the side wall into the forehearth and second and third segments extending from the end of the first segment to the first and second conduit outlets respectively, wherein each second segment and each third segment are at an angle relative to the first segment, so that the axes of the conduit outlets form an angle relative to the side wall of 5 to 30 degrees projected in the horizontal plane and form an angle relative to the horizontal plane of 0 degrees to 5 degrees upward,
refractory material encasing the conduits that protects the conduits from degradation by the forehearth conditions and protects gaseous fuel in the fuel conduit from thermal decomposition, and
a first opening in the refractory material aligned with the first fuel conduit outlet and the first oxidant conduit outlet, wherein the first fuel conduit outlet and the first oxidant conduit outlet are recessed relative to the outer surface of the first opening in the refractory material, and a second opening in the refractory material aligned with the second fuel conduit outlet and the second oxidant conduit outlet, wherein the second fuel conduit outlet and the second oxidant conduit outlet are recessed relative to the outer surface of the second opening in the refractory material, and the first and second openings in the refractory material diverge outwardly from the respective oxidant conduit outlets to the outer surface of the refractory material,
wherein the first and second fuel and oxidant conduit outlets are recessed from the respective first and second refractory openings a distance of 1 to 6 times the inner diameter of the respective oxidant conduit outlets, and
wherein the distance from the axis of the first fuel conduit at its outlet to the side wall from which the burner extends is 4 to 10 times the inner diameter of the outlet of the first oxidant conduit and the distance from the axis of the second fuel conduit at its outlet to the side wall from which the burner extends is 4 to 10 times the inner diameter of the outlet of the second oxidant conduit,
feeding fuel into the fuel conduit inlet at a rate so that the fuel emerges from each fuel conduit outlet at a velocity of 40 to 300 fps and feeding oxidant into the oxidant conduit inlet at a rate so that the oxidant emerges from each oxidant conduit outlet at a velocity of 3 to 100 fps, and the ratio of the oxidant velocity to the fuel velocity at said first oxidant outlet and said first fuel outlet, and the ratio of the oxidant velocity to the fuel velocity at said first oxidant outlet and said first fuel outlet, are each 1:1 to 1:20,
and combusting oxidant and fuel that emerge from said outlets at the first and second openings in the refractory material to produce flames and heat of combustion in close proximity to the sidewall of said glass furnace forehearth.

10. A method according to any of claim 9 further comprising feeding auxiliary oxygen into said forehearth from said burner and combusting furl that emerges from said outlet with auxiliary oxygen.

11. A method according to claim 9 wherein one of said conduits is within the other of said conduits.

12. A method according to claim 11 further comprising feeding auxiliary oxygen into said forehearth from said burner and combusting furl that emerges from said outlet with auxiliary oxygen.
